(19) United States
(12) Patent Application Publication
(10) Pub. No.: US 2016/0139378 A1
(43) Pub. Date: May 19, 2016

(54) ZOOM LENS AND OPTICAL APPARATUS

(71) Applicant: FUJIFILM Corporation, Tokyo (JP)

(72) Inventor: Chikara YAMAMOTO, Saitama-shi (JP)

(73) Assignee: FUJIFILM CORPORATION, Tokyo (JP)

(21) Appl. No.: 14/939,597

(22) Filed: Nov. 12, 2015

(30) Foreign Application Priority Data
Nov. 17, 2014 (JP) 2014-232415

(51) Int. Cl. G02B 15/167; G02B 13/00; G02B 27/00; G02B 15/20

(52) U.S. Cl. CPC G02B 15/167; G02B 15/20; G02B 13/009; G02B 27/0025

(57) ABSTRACT

A zoom lens is equipped with: a first lens group, which is fixed when changing magnification, provided most toward the magnification side; and a second lens group having a positive refractive power, which moves when changing magnification, provided adjacent to the first lens group at the reduction side thereof. The first lens group is constituted essentially by, in order from the magnification side to the reduction side, a front group having a positive refractive power and a rear group having a negative refractive power. Focusing operations are performed by changing the distance between the front group and the rear group. Conditional Formula (1): −0.3 5≦flb/ft<0 related to the focal length flb of the rear group and the focal length ft of the entire lens system at the telephoto end is satisfied.

### CROSS REFERENCE TO RELATED APPLICATIONS

The present application claims priority under 35 U.S.C. §119 to Japanese Patent Application No. 2014-232415 filed on Nov. 17, 2014. The above application is hereby expressly incorporated by reference, in its entirety, into the present application.

### BACKGROUND

The present disclosure is related to a zoom lens and an optical apparatus. More particularly, the present disclosure is related to a zoom lens which is favorably suited for use in projection optical systems which are employed in projection type display apparatuses, as well as in imaging optical systems which are employed in digital cameras, video cameras, and the like, and to an optical apparatus in which the zoom lens is mounted.

Conventionally, imaging optical systems that capture images of subjects at the magnification side and form images onto imaging elements at the reduction side are employed in cameras in the above fields. In addition, projection optical systems that project optical images formed by light modulated by modulating elements provided at the reduction side toward the magnification side are conventionally employed in projection type display apparatuses. In these projection optical systems and imaging optical systems, zoom lenses, which are capable of assuming states with various focal lengths with a single optical system, are becoming mainstream.

Among these, long focus zoom lenses are proposed in Japanese Unexamined Patent Publication Nos. 8(1996)-334692, 10(1998)-090599, 2004-145304, and 2001-066501, for example. Japanese Unexamined Patent Publication Nos. 8(1996)-334692, 10(1998)-090599, and 2004-145304 disclose zoom lenses in which a first lens group, which is fixed when changing magnification, is provided at the most magnification side, and a second lens group having a negative refractive power, which moves when changing magnification, is provided immediately adjacent to the first lens group at the reduction side thereof Japanese Unexamined Patent Publication No. 2001-066501 discloses a zoom lens in which a first lens group, which is fixed when changing magnification, is provided at the most magnification side, and a second lens group having a positive refractive power, which moves when changing magnification, is provided immediately adjacent to the first lens group at the reduction side thereof.

### SUMMARY

Generally, lens systems adapted to long focus are systems in which the angle of view at the magnification side is narrow. Such long focus lens systems having narrow angles of view at the magnification side have a shortcoming that the size of the optical system becomes greater proportionate to the focal length. Recently, there is great demand for miniaturization of long focus lens systems as well, and further for these lens systems to have small F numbers.

However, the zoom lenses disclosed in Japanese Unexamined Patent Publication Nos. 8(1996)-334692, 10(1998)-090599, and 2004-145304 have F numbers of 4 or greater, and it cannot be said that these lens systems have small F numbers. In these lens systems, the second lens group, which is a movable lens group provided immediately toward the reduction side of the fixed first lens group, is a negative lens group. Therefore, configuring an optical system having a small F number is difficult. The zoom lens disclosed in Japanese Unexamined Patent Publication No. 2001-066501 is a large optical system proportionate to the focal length thereof. It cannot be said that this lens system satisfies recent demand for miniaturization.

The present disclosure has been developed in view of the foregoing circumstances. The present disclosure provides a zoom lens having a long focus, is compact, has a small F number, and exhibits favorable optical performance. The present disclosure also provides an optical apparatus equipped with this zoom lens.

A zoom lens of the present disclosure comprises:

a first lens group, which is fixed when changing magnification, provided most toward the magnification side; and

a second lens group having a positive refractive power, which moves when changing magnification, provided adjacent to the first lens group at the reduction side of the first lens group;

the first lens group consisting essentially of, in order from the magnification side to the reduction side, a front group having a positive refractive power and a rear group having a negative refractive power, focusing operations being performed by changing the distance between the front group and the rear group; and

Conditional Formula (1) below being satisfied:

−0.35≦flb/ft<0 (1)

wherein flb is the focal length of the rear group, and ft is the focal length of the entire lens system at the telephoto end.

In the zoom lens of the present disclosure, it is preferable for any one or arbitrary combinations of Conditional Formulae (2) through (4) and (1-1) through (4-1) to be satisfied.

−0.29≦flb/ft≦−0.05 (1-1)

0.5≦TLt/ft≦1.5 (2)

0.6≦TLt/ft≦1.4 (2-1)

0.1≦D1G/DLt≦0. 45 (3)

0.2≦D1G/DLt≦0.4 (3-1)

0.05≦Bfw/fw≦0.4 (4)

0.1≦Bfw/fw≦0.35 (4-1)

wherein flb is the focal length of the rear group, ft is the focal length of the entire lens system at the telephoto end, TLt is the sum of the distance along the optical axis from the lens surface most toward the magnification side to the lens surface most toward the reduction side and an air converted distance from the lens surface most toward the reduction side to the reduction side focal point position at the telephoto end, D1G is the distance along the optical axis from the lens surface most toward the magnification side to the lens surface most toward the reduction side within the first lens group, DLt is the distance along the optical axis from the lens surface most toward the magnification side to the lens surface most toward the reduction side at the telephoto end, Bfw is an air converted distance from the lens surface most toward the reduction side to the reduction side focal point position at the wide angle end, and fw is the focal length of the entire lens system at the wide angle end.

In the zoom lens of the present disclosure, it is preferable for a lens group having a positive refractive power, which is fixed when changing magnification, to be provided most toward the reduction side, and for the reduction side to be configured to be telecentric.

The zoom lens of the present disclosure may be configured such that the entire lens system consists essentially of five or six lens groups, and the distances among adjacent lens groups change when changing magnification.

The zoom lens of the present disclosure may consist essentially of, in order from the magnification side to the reduction side,

the first lens group;

the second lens group;

a third lens group having a positive refractive power;

a fourth lens group having a negative refractive power;

a fifth lens group having a negative refractive power; and

a sixth lens group having a positive refractive power;

the second lens group, the third lens group, the fourth lens group, and the fifth lens group being moved such that the distances among adjacent lens groups change when changing magnification; and

the sixth lens group being fixed when changing magnification.

The zoom lens of the present disclosure may consist essentially of, in order from the magnification side to the reduction side,

the first lens group;

the second lens group;

a third lens group having a positive refractive power;

a fourth lens group having a negative refractive power; and

a fifth lens group having a positive refractive power;

the second lens group, the third lens group, and the fourth lens group, being moved such that the distances among adjacent lens groups change when changing magnification; and

the fifth lens group being fixed when changing magnification.

An optical apparatus of the present disclosure is equipped with the zoom lens of the present disclosure.

Note that the expression “essentially” in the phrase “consists essentially of” means that the zoom lens may also include lenses that practically do not have any power, optical elements other than lenses such as an aperture stop and a cover glass, and mechanical components such as lens flanges, a lens barrel, an imaging element, a blur correcting mechanism, etc., in addition to the constituent elements listed above.

Note that the expressions “lens group”, “front group”, and “rear group” are not necessarily those constituted by a plurality of lenses, and include groups which are constituted by a single lens.

Note that the signs of the refractive powers of the “lens group”, “front group”, and “rear group” are those which are considered in the paraxial regions thereof in cases that aspherical surfaces are included therein.

Note that ft, TLt, D1G, and DLt in the conditional formulae above are those for cases in which the magnification side conjugate point is at infinity.

In the present disclosure, the first lens group, which is provided most toward the magnification side and is fixed when changing magnification, is of a telephoto type configuration constituted by a positive front group and a negative rear group, the distance between which changes during focusing operations. Further, the refractive power of the rear group is set favorably such that a predetermined conditional formula is satisfied. In addition, the second lens group, which is provided immediately toward the reduction side of the first lens group and moves when changing magnification, is a positive lens group. Therefore, a compact zoom lens having a long focus, a small F number, and favorable optical properties, as well as an optical apparatus equipped with this zoom lens, can be provided.

### BRIEF DESCRIPTION OF THE DRAWINGS

FIG. 1 is a collection of sectional diagrams that illustrate the lens configuration of a zoom lens according to an embodiment of the present disclosure (a zoom lens corresponding to Example 1.

FIG. 2 is a collection of sectional diagrams that illustrate the lens configuration and the paths of light rays through the zoom lens of FIG. 1 at the wide angle end.

FIG. 3 is a sectional diagram that illustrates the lens configuration of a zoom lens according to Example 2 of the present disclosure.

FIG. 4 is a collection of sectional diagrams that illustrate the lens configuration and the paths of light rays through the zoom lens of Example 2 at the wide angle end.

FIG. 5 is a sectional diagram that illustrates the lens configuration of a zoom lens according to Example 3 of the present disclosure.

FIG. 6 is a sectional diagram that illustrates the lens configuration and the paths of light rays through the zoom lens of Example 3 at the wide angle end.

FIG. 7 is a collection of diagrams that illustrate various aberrations of the zoom lens according to Example 1, wherein the diagrams illustrate spherical aberration, astigmatism, distortion, and lateral chromatic aberration in order from the left side of the drawing sheet.

FIG. 8 is a collection of diagrams that illustrate various aberrations of the zoom lens according to Example 2, wherein the diagrams illustrate spherical aberration, astigmatism, distortion, and lateral chromatic aberration in order from the left side of the drawing sheet.

FIG. 9 is a collection of diagrams that illustrate various aberrations of the zoom lens according to Example 3, wherein the diagrams illustrate spherical aberration, astigmatism, distortion, and lateral chromatic aberration in order from the left side of the drawing sheet.

FIG. 10 is a diagram that schematically illustrates the configuration of a projection type display apparatus according as a first embodiment of an optical apparatus of the present disclosure.

FIG. 11 is a diagram that schematically illustrates the configuration of a projection type display apparatus according as a second embodiment of the optical apparatus of the present disclosure.

FIG. 12A is a perspective view that illustrates the front side of an imaging apparatus as a third embodiment of the optical apparatus of the present disclosure.

FIG. 12B is a perspective view that illustrates the rear side of the imaging apparatus illustrated in FIG. 12A.

### DETAILED DESCRIPTION OF THE PREFERRED EMBODIMENTS

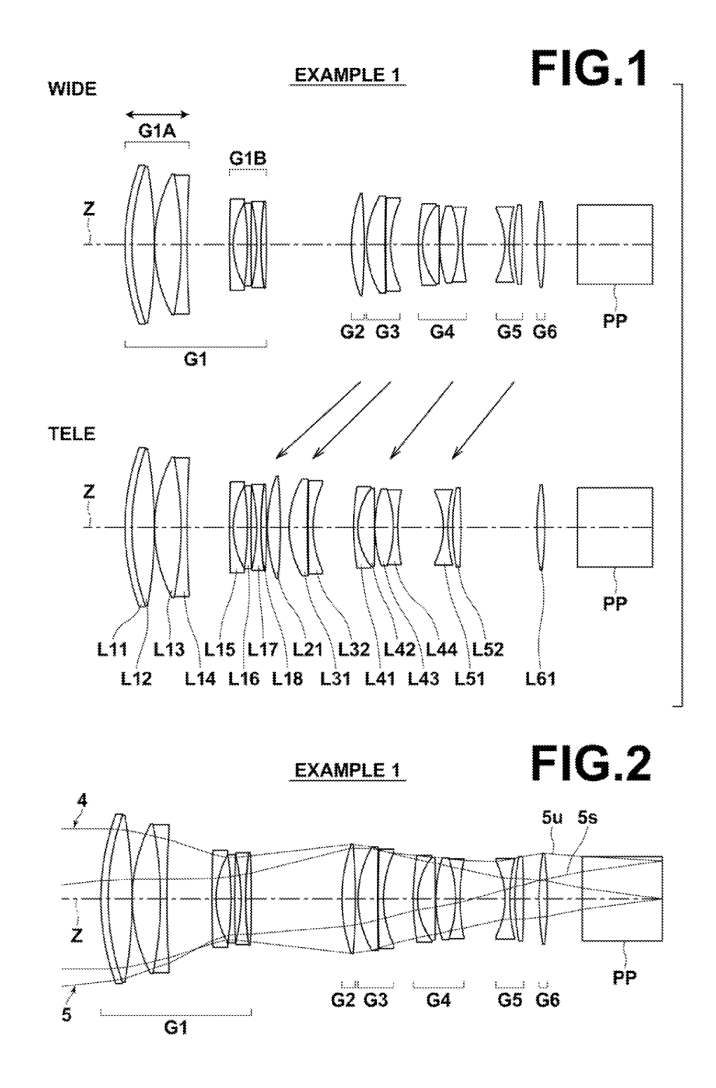

Hereinafter, embodiments of the present disclosure will be described in detail with reference to the attached drawings. FIG. 1 and FIG. 2 are cross sectional diagrams that illustrate the configuration of a zoom lens according to an embodiment of the present disclosure, which corresponds to a zoom lens of Example 1 to be described later. In FIG. 1 and FIG. 2, the left side is the magnification side, and the right side is the reduction side.

The upper portion of FIG. 1 labeled “WIDE” illustrates the state of the zoom lens at the wide angle end, and the lower portion of FIG. 1 labeled “TELE” illustrates the state of the zoom lens at the telephoto end. Arrows that schematically indicate the directions of movement of each lens group as magnification is changed from the wide angle end to the telephoto end are illustrated between the upper portion and the lower portion of FIG. 1. In addition, a double headed arrow is illustrated above the lens group that moves during focusing operations in FIG. 1. Note that in FIG. 1, the signs of each lens group, the signs of each lens, and the double headed arrow are not indicated in both the upper portion and the lower portion, but are only indicated in one of the upper portion and the lower portion, in order to avoid the drawing becoming complex. FIG. 2 is a sectional diagram of the lens that also illustrates the optical paths of an axial light beam 4 and a light beam 5 at a maximum image angle of view, as well as a light ray 5u at the maximum angle of view at the upper side and a light ray 5s at the maximum angle of view at the lower side included in the light beam 5 at the maximum angle of view, that pass through this zoom lens from an object at infinity.

The example illustrated in FIG. 1 and FIG. 2 is a zoom lens having a six group configuration, in which a first lens group G1 through a sixth lens group G6 are provided in order from the magnification side to the reduction side. The first lens group G1 and the sixth lens group G6 are fixed, and the second lens group G2 through the fifth lens group G5 move along the direction of the optical axis when changing magnification. However, in the zoom lens of the present disclosure, the number of lens groups that constitute the entire lens system and the movements of the lens groups provided more toward the reduction side than the second lens group G2 when changing magnification are not limited to those of the example illustrated in FIG. 1.

The zoom lens of the present embodiment is capable of being mounted in an imaging apparatus and utilized as an imaging optical system for imaging subjects, for example. Alternatively, the zoom lens of the present embodiment is capable of being mounted in a projection type display apparatus and utilized as a projection zoom lens that projects image information displayed on a light valve onto a screen.

When this zoom lens is mounted in an imaging apparatus or a projection type display apparatus, prisms, various filters, a cover glass, etc. may be provided at the reduction side of the lens system. Therefore, FIG. 1 and FIG. 2 illustrate an example in which an optical member PP having parallel flat surfaces that presumes such components is provided. However, the optical member PP is not an essential constituent element of the present disclosure. In addition, FIG. 1 and FIG. 2 illustrate an example in which the reduction side conjugate point is positioned on the surface of the optical member PP toward the reduction side. However, the present disclosure is not necessarily limited to such a configuration.

The zoom lens of the present embodiment is equipped with the first lens group G1, which is provided most toward the magnification side and is fixed when changing magnification, and a second lens group G2, which is provided adjacent to the first lens group G1 toward the reduction side thereof, moves when changing magnification, and has a positive refractive power. The first lens group G1 is constituted essentially by, in order from the magnification side to the reduction side, a front group G1A having a positive refractive power, and a rear group G1B having a negative refractive power. Focusing is performed by changing the distance between the front group G1A and the rear group G1B. Further, Conditional Formula (1) below is satisfied in this zoom lens.

−0.35≦flb/ft<0 (1)

wherein flb is the focal length of the rear group, and ft is the focal length of the entire lens system at the telephoto end.

Miniaturization of the optical system is facilitated by configuring the first lens group G1 to be of a telephoto type constituted by, in order from the magnification side to the reduction side, the front group G1A having a positive refractive power, and the rear group G1B having a negative refractive power. This configuration is advantageous from the viewpoint of realizing a compact zoom lens having a long focus.

By arranging refractive power such that Conditional Formula (1) is satisfied while being of the aforementioned telephoto type configuration is further advantageous from the viewpoint of realizing a compact zoom lens having a long focus. The rear group G1B will have an appropriate amount of negative refractive power, by configuring the zoom lens such that the value of flb/ft is greater than or equal to the lower limit defined in Conditional Formula (1). As a result, the advantageous effects of the telephoto type configuration can be favorably exhibited, and miniaturization can be achieved. The rear group G1B will be a negative lens group, by configuring the zoom lens such that the value of flb/ft is not greater than or equal to the upper limit defined in Conditional Formula (1). Aberrations can be corrected more favorably by setting the range of the refractive power of the rear group G1B such that Conditional Formula (1-1) below is satisfied, and such a configuration is also advantageous from the viewpoint of miniaturization.

−0.29≦flb/ft≦0.05 (1-1)

In this zoom lens, the second lens group G2, which is provided after the positive front group G1A and the negative rear group G1B, is a positive lens group. By adopting such a power arrangement, light beams to which a diverging effect are imparted by the rear group G1B having a negative refractive power, receive a converging effect from the second lens group G2. Therefore, the heights of light rays can be suppressed, and realization of an optical system having a small F number is facilitated compared to a case in which the second lens group G2 is a negative lens group.

In addition, by performing focusing operations by changing the distance between the front group G1A and the rear group G1B, which are fixed when changing magnification, fluctuations in zoom ratios due to focusing operations can be avoided. In addition, by designating lens groups as those that move when changing magnification and those that move during focusing operations, a zoom mechanism and a focusing mechanism can be separated, which contributes to simplification of these mechanisms. Focusing operations may be performed by moving only the front group G1A, by moving only the rear group G1B, or by moving both the front group G1A and the rear group G1B.

In the zoom lens of the present embodiment, it is preferable for any one or arbitrary combinations of Conditional Formulae (2) through (4) below to be satisfied.

0.5≦TLt/ft≦1.5 (2)

0.1≦D1G/DLt≦0.45 (3)

0.05≦Bfw/fw≦0.4 (4)

wherein ft is the focal length of the entire lens system at the telephoto end, TLt is the sum of the distance along the optical axis from the lens surface most toward the magnification side to the lens surface most toward the reduction side and an air converted distance from the lens surface most toward the reduction side to the reduction side focal point position at the telephoto end, D1G is the distance along the optical axis from the lens surface most toward the magnification side to the lens surface most toward the reduction side within the first lens group, DLt is the distance along the optical axis from the lens surface most toward the magnification side to the lens surface most toward the reduction side at the telephoto end, Bfw is an air converted distance from the lens surface most toward the reduction side to the reduction side focal point position at the wide angle end, and fw is the focal length of the entire lens system at the wide angle end.

Various aberrations can be favorably corrected, by configuring the zoom lens such that the value of TLt/ft is greater than or equal to the lower limit defined in Conditional Formula (2). The optical system can be configured to be compact, by configuring the zoom lens such that the value of TLt/ft is less than or equal to the upper limit defined in Conditional Formula (2). It is more preferable for Conditional Formula (2-1) below to be satisfied, in order to cause the above advantageous effects related to Conditional Formula (2) to become more prominent.

0.6≦TLt/ft≦1.4 (2-1)

The advantageous effect of miniaturization obtained by the first lens group G1 can be sufficiently exhibited and the optical system as a whole can be configured to be compact, by configuring the zoom lens such that the value of D1G/DLt is greater than or equal to the lower limit defined in Conditional Formula (3). A movement region for the lens groups when changing magnification can be secured, and a practical zoom ratio can be obtained, by configuring the zoom lens such that the value of D1G/DLt is less than or equal to the upper limit defined in Conditional Formula (3). In addition, adopting this configuration also enables aberrations to be favorably corrected when changing magnification. It is more preferable for Conditional Formula (3-1) below to be satisfied, in order to cause the above advantageous effects related to Conditional Formula (3) to become more prominent.

0.2≦D1G/DLt≦0.4 (3-1)

A sufficient amount of back focus necessary for providing a color combining prism or the like in the case that this zoom lens is employed in a projection type display apparatus, by configuring the zoom lens such that the value of Bfw/fw is greater than or equal to the lower limit defined in Conditional Formula (4). In addition, adopting such a configuration will enable mechanical interference with an imaging element to be prevented, in the case that this zoom lens is combined with the imaging element and employed in an imaging apparatus. Miniaturization of the optical system as a whole and suppression of the diameters of lenses toward the reduction side will become possible, by configuring the zoom lens such that the value of Bfw/fw is less than or equal to the upper limit defined in Conditional Formula (4). It is more preferable for Conditional Formula (4-1) below to be satisfied, in order to cause the above advantageous effects related to Conditional Formula (4) to become more prominent.

0.1≦Bfw/fw≦0.35 (4-1)

It is preferable for the zoom lens of the present embodiment to be provided with a lens group, which is fixed when changing magnification and has a positive refractive power, to be provided most toward the reduction side, and for the reduction side to be configured to be telecentric. Configuring the reduction side to be telecentric is facilitated by providing the lens group having a positive refractive power most toward the reduction side. Maintaining the configuration in which the reduction side is telecentric even while changing magnification is facilitated, by the lens group most toward the reduction side being fixed when changing magnification.

A high light entrance efficiency into an imaging element can be secured in the case that this zoom lens is employed as an imaging optical system in combination with an imaging element such as a CCD (Charge Coupled Device), by configuring the reduction side to be telecentric. Favorable optical properties can be obtained even if an optical member which has properties that depend on the incident angles of light, such as a color combining prism, is provided at the reduction side of the lens system in the case that this zoom lens is employed as a projection optical system, by configuring the reduction side to be telecentric.

Note that the expression “the reduction side is telecentric” means that an angular line that bisects the cross section of a light beam focused at an arbitrary point on a conjugate surface at the reduction side between the maximum ray of light at the upper side and the maximum ray of light at the lower side thereof is close to being parallel with the optical axis Z, when a light beam is viewed in a direction from the magnification side toward the reduction side. The expression “the reduction side is telecentric” is not limited to cases in which the reduction side is completely telecentric, that is, cases in which the bisecting angular line is completely parallel to the optical axis Z, but also refers to cases in which a certain degree of error is present. Here, the certain degree of error refers to a range of inclination between the bisecting angular line and the optical axis Z within a range from −5° to +5°. In a lens system having an aperture stop, the expression “the reduction side is telecentric” means that the inclination of a principal light ray with respect to the optical axis Z is within a range from −5° to +5°.

Note that the zoom lens of the present disclosure may be configured such that the entire lens system consists essentially of five or six lens groups, the distances among adjacent lens groups changing when changing magnification. In this case, fluctuations in aberrations while changing magnification can be decreased, which is advantageous from the viewpoint of achieving high performance.

For example, the zoom lens of the present disclosure may consist essentially of, in order from the magnification side to the reduction side, a first lens group G1 constituted by the front group G1A having a positive refractive power and the rear group G1B having a negative refractive power, the second lens group G2 having a positive refractive power, a third lens group G3 having a positive refractive power, a fourth lens group G4 having a negative refractive power, a fifth lens group G5 having a negative refractive power, and a sixth lens group G6 having a positive refractive power as in the example illustrated in FIG. 1. The zoom lens may be configured such that the second lens group G2, the third lens group G3, the fourth lens group G4, and the fifth lens group G5 move such that the distances among adjacent lens groups change while the first lens group G1 and the sixth lens group G6 are fixed when changing magnification. The example illustrated in FIG. 1 has such a six group configuration, and is configured such that the second lens group G2, the third lens group G3, the fourth lens group G4, and the fifth lens group G5 move toward the magnification side when changing magnification from the wide angle end to the telephoto end.

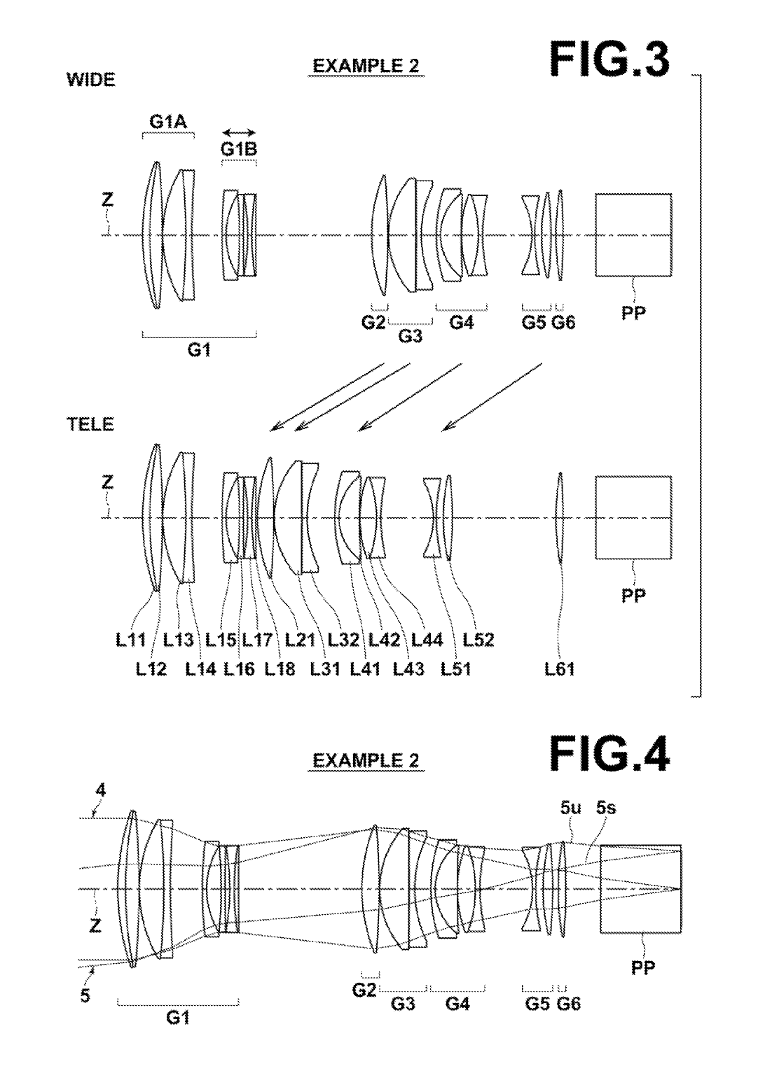

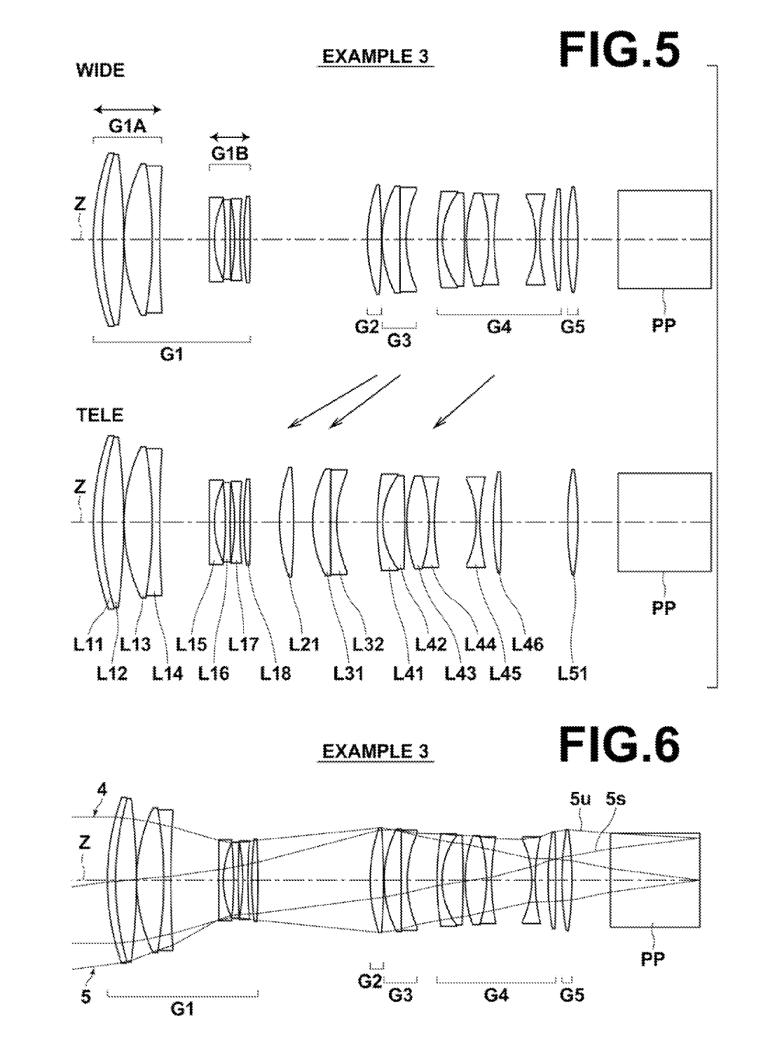

Alternatively, the zoom lens of the present disclosure may consist essentially of, in order from the magnification side to the reduction side, a first lens group G1 constituted by the front group G1A having a positive refractive power and the rear group G1B having a negative refractive power, the second lens group G2 having a positive refractive power, a third lens group G3 having a positive refractive power, a fourth lens group G4 having a negative refractive power, and a fifth lens group G5 having a positive refractive power as in the example illustrated in FIG. 5 corresponding to Example 3 to be described later. The zoom lens may be configured such that the second lens group G2, the third lens group G3, and the fourth lens group G4 move such that the distances among adjacent lens groups change while the first lens group G1 and the fifth lens group G5 are fixed when changing magnification. The example illustrated in FIG. 3 has such a five group configuration, and is configured such that the second lens group G2, the third lens group G3, and the fourth lens group G4 move toward the magnification side when changing magnification from the wide angle end to the telephoto end.

The present disclosure is applicable to zoom lenses having F numbers of less than 2.6 at the wide angle end.

Arbitrary combinations of the preferred configurations and the possible configurations described above are possible. It is preferable for the configurations to be selectively adopted as appropriate, according to specifications required of the zoom lens.

Next, examples of numerical values of the zoom lens of the present disclosure will be described. Note that the numerical value data of the examples to be indicated hereinbelow are those which are normalized such that the focal length of the entire lens system at the wide angle end when the magnification side conjugate point is at infinity will be 1.00, and are rounded off at a predetermined number of digits.

### EXAMPLE 1

The configuration of the zoom lens of Example 1 is illustrated in FIG. 1 and FIG. 2. The zoom lens of Example 1 is of a six group configuration substantially consisting of the first lens group G1 through the sixth lens group G6. The first lens group G1 has a negative refractive power as a whole, and is constituted by the front group G1A and the rear group G1B. The front group G1A is constituted by a lens L11 through a lens L14. The rear group G1B is constituted by a lens L15 through a lens L18. The second lens group G2 is constituted only by a lens L21. The third lens group G3 is constituted by a lens L31 and a lens L32. The fourth lens group G4 is constituted by a lens L41 through a lens L44. The fifth lens group G5 is constituted by a lens L51 and a lens L52. The sixth lens G6 is constituted only by a lens L61. Focusing operations are performed by moving only the front group G1A in the direction of the optical axis.

Basic lens data of Example 1 are shown in Table 1, and items and variable distances among surfaces of Example 1 are shown in Table 2. In Table 1, ith (i=1, 2, 3, . . . ) surface numbers that sequentially increase from the magnification side to the reduction side, with the surface toward the magnification side of the constituent element at the most magnification side designated as first, are shown in the column Si. The radii of curvature of ith surfaces are shown in the column Ri, the distances along the optical axis Z between an ith surface and an i+1st surface are shown in the column Di. The refractive indices with respect to the d line (wavelength: 587.6 nm) of jth (j=1, 2, 3, . . . ) constituent elements that sequentially increase from the magnification side to the reduction side, with the constituent element at the most magnification side designated as first, are shown in the column Ndj. The Abbe's numbers of jth constituent elements with respect to the d line are shown in the column vdj.

Note that the signs of the radii of curvature are positive in cases that the surface shape is convex toward the magnification side, and negative in cases that the surface shape is convex toward the reduction side. Table 1 also shows the optical member PP. In Table 1, variable distances are indicated by DD [ ]. The surface number toward the magnification side is shown in the brackets [ ], and written in the column Di. That is, DD [6], DD [14], DD [16], DD [20], DD [27], and DD [31] respectively correspond to the distance between the front group G1A and the rear group G1B, the distance between the first lens group G1 and the second lens group G2, the distance between the second lens group G2 and the third lens group G3, the distance between the third lens group G3 and the fourth lens group G4, the distance between the fourth lens group G4 and the fifth lens group G5, and the distance between the fifth lens group G5 and the sixth lens group G6.

The zoom ratio Zr, the range of F numbers FNo. and the range of the full angle of view 2ω (units are degrees) for the zoom lens of Example 1 in the case that magnification is changed from the wide angle end to the telephoto end are shown beneath the frame of Table 1. The F numbers and the full angles of view shown in Table 1 are those for a case in which the distance from the lens surface most toward the magnification side to the magnification side conjugate point is 107.5.

Table 2 shows the values of the above variable distances among surfaces at each zoom state and focus state. The magnification state is shown toward the left side of the “−”, and the distance from the lens surface most toward the magnification side to the magnification side conjugate point is shown toward the right side of the “−” in the uppermost row of Table 2. In the uppermost row of Table 2, W denotes a state at the wide angle end, T denotes a state at the telephoto end, and INF denotes infinity.

TABLE 1
Example 1

| Si | Ri | Di | Ndj | νdj |
|---|---|---|---|---|
| 1 | 0.700 | 0.02 | 1.7550 | 52.3 |
| 2 | 0.718 | 0.07 | 1.4388 | 94.9 |
| 3 | −1.403 | 0.00 | | |
| 4 | 0.459 | 0.08 | 1.4970 | 81.5 |
| 5 | −1.076 | 0.02 | 1.7292 | 54.7 |
| 6 | 3.092 | DD[6] | | |
| 7 | 3.255 | 0.01 | 1.5317 | 48.8 |
| 8 | 0.254 | 0.04 | | |
| 9 | −0.924 | 0.01 | 1.6968 | 55.5 |
| 10 | 4.793 | 0.02 | | |
| 11 | −0.517 | 0.01 | 1.6516 | 58.5 |
| 12 | 1.018 | 0.00 | | |
| 13 | 0.962 | 0.02 | 1.8467 | 23.8 |
| 14 | −2.835 | DD[14] | | |
| 15 | 0.459 | 0.04 | 1.6030 | 65.4 |
| 16 | −1.926 | DD[16] | | |
| 17 | 0.293 | 0.06 | 1.6204 | 60.3 |
| 18 | 4.909 | 0.00 | | |
| 19 | 5.563 | 0.02 | 1.5814 | 40.7 |
| 20 | 0.314 | DD[20] | | |
| 21 | 0.701 | 0.01 | 1.8340 | 37.2 |
| 22 | 0.193 | 0.00 | | |
| 23 | 0.193 | 0.05 | 1.5891 | 61.1 |
| 24 | −5.567 | 0.00 | | |
| 25 | 0.364 | 0.06 | 1.6204 | 60.3 |
| 26 | −0.353 | 0.01 | 1.8348 | 42.7 |
| 27 | 0.553 | DD[27] | | |
| 28 | −0.236 | 0.01 | 1.5317 | 48.8 |
| 29 | 0.465 | 0.01 | | |
| 30 | 0.620 | 0.03 | 1.8467 | 23.8 |
| 31 | −2.180 | DD[31] | | |
| 32 | 0.829 | 0.02 | 1.8348 | 42.7 |
| 33 | −1.027 | 0.10 | | |
| 34 | ∞ | 0.23 | 1.5163 | 64.1 |
| 35 | ∞ | | | |

Zr = 1.64,
FNo. = 2.51~3.90,
2ω = 12.4°~7.4°

TABLE 2
Example 1

| | W-INF | T-INF | W-107.5 | T-107.5 | W-61.3 | T-61.3 |
|---|---|---|---|---|---|---|
| DD [6] | 0.128 | 0.128 | 0.132 | 0.132 | 0.135 | 0.135 |
| DD [14] | 0.257 | 0.003 | 0.257 | 0.003 | 0.257 | 0.003 |
| DD [16] | 0.008 | 0.026 | 0.008 | 0.026 | 0.008 | 0.026 |
| DD [20] | 0.257 | 0.297 | 0.257 | 0.297 | 0.257 | 0.297 |
| DD [27] | 0.128 | 0.138 | 0.128 | 0.138 | 0.128 | 0.138 |
| DD [31] | 0.044 | 0.230 | 0.044 | 0.230 | 0.044 | 0.230 |

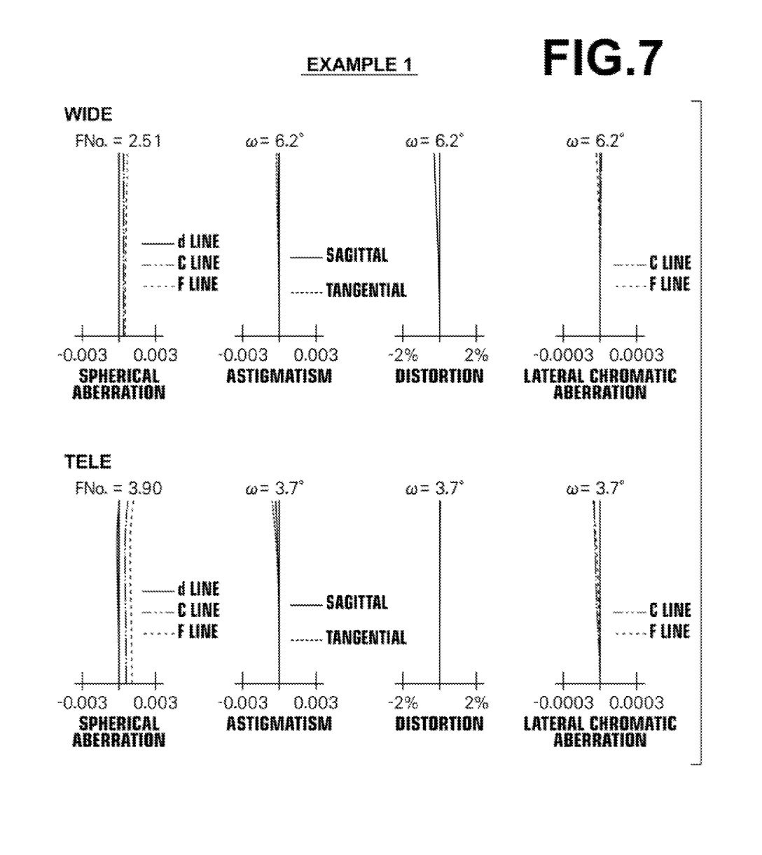

The spherical aberration, the astigmatic aberration, the distortion, and the lateral chromatic aberration (aberration of magnification) of the zoom lens of Example 1 are illustrated in the aberration diagrams of FIG. 7 in order from the left side of the drawing sheet. Aberrations at the wide angle end are illustrated in the upper portion of FIG. 7 labeled WIDE, and aberrations at the telephoto end are illustrated in the lower portion of FIG. 7 labeled TELE. In the diagrams that illustrate spherical aberration in FIG. 7, aberrations related to the d line (wavelength: 587.6 nm), the C line (wavelength: 656.3 nm), and the F line (wavelength: 486.1 nm) are indicated by a solid line, a two point chain line, and a broken line, respectively. In the diagrams that illustrate astigmatism, aberrations related to the d line in the sagittal direction and the tangential direction are indicated by a solid line and a broken line, respectively. In the diagrams that illustrate distortion, aberration related to the d line is indicated by a solid line. In the diagrams that illustrate lateral chromatic aberration, aberrations related to the C line and the F line are indicated by a two point chain line and a broken line, respectively. In the diagrams that illustrate spherical aberration, “FNo.” denotes F numbers, and in the diagrams that illustrate other aberrations, “ω” denotes half angles of view. The aberrations illustrated in FIG. 7 are those for a case in which the distance from the lens surface most toward the magnification side to the magnification side conjugate point is 107.5.

The symbols, the meanings, and the manner in which the data are shown in the description of Example 1 above are the same for the following Examples to be described later, unless particularly noted. Therefore, redundant descriptions thereof will be omitted below.

### EXAMPLE 2

The lens configuration of the zoom lens according to Example 2 is illustrated in FIG. 3, and the paths of light therethrough at the wide angle end are illustrated in FIG. 4. The zoom lens of Example 2 is of a six group configuration substantially consisting of a first lens group G1 through a sixth lens group G6. The first lens group G1 has a negative refractive power as a whole, and is constituted by a front group G1A and a rear group G1B. The front group G1A is constituted by a lens L11 through a lens L14. The rear group G1B is constituted by a lens L15 through a lens L18. A second lens group G2 is constituted only by a lens L21. A third lens group G3 is constituted by a lens L31 and a lens L32. A fourth lens group G4 is constituted by a lens L41 through a lens L44. A fifth lens group G5 is constituted by a lens L51 and a lens L52. The sixth lens G6 is constituted only by a lens L61. Focusing operations are performed by moving only the rear group G1B in the direction of the optical axis.

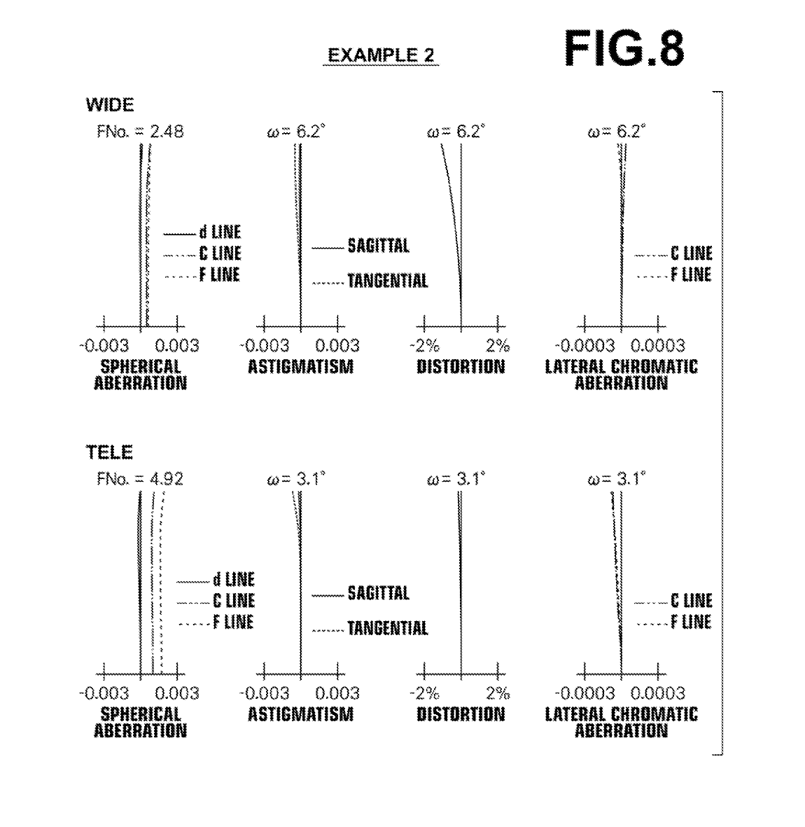

Basic lens data and the value of variable distances among surfaces for the zoom lens of Example 2 are shown in Table 3 and Table 4, respectively. FIG. 8 illustrates the spherical aberration, the astigmatism, the distortion, and the lateral chromatic aberration of the zoom lens of Example 2 in aberration diagrams which are arranged in order from the left side of the drawing sheet. The F numbers and the full angles of view shown in Table 3 as well as the aberrations illustrated in FIG. 8 are those for a case in which the distance from the lens surface most toward the magnification side to the magnification side conjugate point is 108.0.

TABLE 3
Example 2

| Si | Ri | Di | Ndj | νdj |
|---|---|---|---|---|
| 1 | 0.676 | 0.02 | 1.8340 | 37.2 |
| 2 | 1.123 | 0.04 | 1.4970 | 81.5 |
| 3 | −2.389 | 0.00 | | |
| 4 | 0.392 | 0.07 | 1.4970 | 81.5 |
| 5 | −1.972 | 0.02 | 1.8348 | 42.7 |
| 6 | 2.418 | DD [6] | | |
| 7 | 1.275 | 0.01 | 1.6056 | 43.7 |
| 8 | 0.234 | 0.04 | | |
| 9 | −1.297 | 0.01 | 1.7550 | 52.3 |
| 10 | 5.099 | 0.01 | | |
| 11 | −0.649 | 0.01 | 1.7130 | 53.9 |
| 12 | 0.855 | 0.01 | 1.8081 | 22.8 |
| 13 | 4.606 | DD [13] | | |
| 14 | 0.477 | 0.05 | 1.5952 | 67.7 |
| 15 | −2.010 | DD [15] | | |
| 16 | 0.261 | 0.08 | 1.5378 | 74.7 |
| 17 | −37.991 | 0.00 | | |
| 18 | −17.957 | 0.02 | 1.4875 | 70.2 |
| 19 | 0.344 | DD [19] | | |
| 20 | 0.442 | 0.01 | 1.8503 | 32.3 |
| 21 | 0.160 | 0.06 | 1.4970 | 81.5 |
| 22 | 1.841 | 0.00 | | |
| 23 | 0.353 | 0.05 | 1.6034 | 38.0 |
| 24 | −0.356 | 0.01 | 1.8340 | 37.2 |
| 25 | 0.503 | DD [25] | | |
| 26 | −0.226 | 0.01 | 1.5378 | 74.7 |
| 27 | 0.526 | 0.02 | | |
| 28 | 0.565 | 0.03 | 1.7283 | 28.5 |
| 29 | −1.148 | DD [29] | | |
| 30 | 0.779 | 0.02 | 1.8348 | 42.7 |
| 31 | −1.589 | 0.10 | | |
| 32 | ∞ | 0.23 | 1.5163 | 64.1 |
| 33 | ∞ | | | |

Zr = 1.98,
FNo. = 2.48~4.92,
2ω = 12.4°~6.2°

TABLE 4
Example 2

| | W-INF | T-INF | W-108.0 | T-108.0 | W-74.6 | T-74.6 |
|---|---|---|---|---|---|---|
| DD [6] | 0.091 | 0.091 | 0.094 | 0.094 | 0.095 | 0.095 |
| DD [13] | 0.352 | 0.006 | 0.349 | 0.003 | 0.348 | 0.002 |
| DD [15] | 0.002 | 0.001 | 0.002 | 0.001 | 0.002 | 0.001 |
| DD [19] | 0.046 | 0.084 | 0.046 | 0.084 | 0.046 | 0.084 |
| DD [25] | 0.149 | 0.159 | 0.149 | 0.159 | 0.149 | 0.159 |
| DD [29] | 0.015 | 0.314 | 0.015 | 0.314 | 0.015 | 0.314 |

### EXAMPLE 3

The lens configuration of the zoom lens according to Example 3 is illustrated in FIG. 5, and the paths of light therethrough at the wide angle end are illustrated in FIG. 6. The zoom lens of Example 3 is of a five group configuration substantially consisting of a first lens group G1 through a fifth lens group G5. The first lens group G1 has a negative refractive power as a whole, and is constituted by a front group G1A and a rear group G1B. The front group G1A is constituted by a lens L11 through a lens L14. The rear group G1B is constituted by a lens L15 through a lens L18. A second lens group G2 is constituted only by a lens L21. A third lens group G3 is constituted by a lens L31 and a lens L32. A fourth lens group G4 is constituted by a lens L41 through a lens L46. The fifth lens group G5 is constituted only by a lens L51. Focusing operations are performed by the floating focus method, in which both the front group G1A and the rear group G1B are moved in the direction of the optical axis such that the distance therebetween changes.

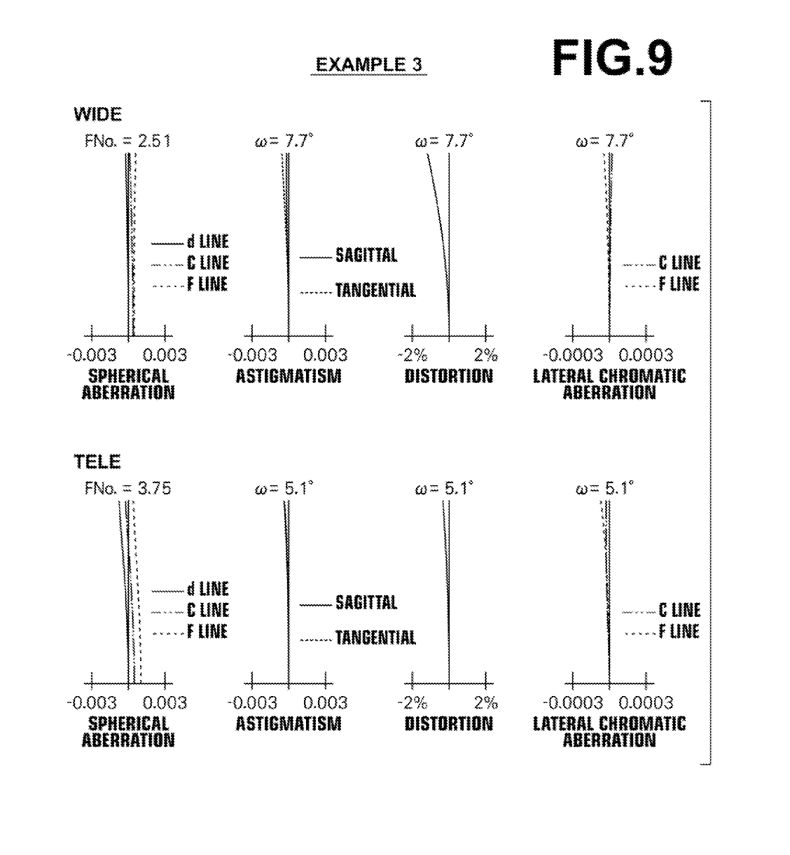

Basic lens data and the value of variable distances among surfaces for the zoom lens of Example 3 are shown in Table 5 and Table 6, respectively. FIG. 9 illustrates the spherical aberration, the astigmatism, the distortion, and the lateral chromatic aberration of the zoom lens of Example 3 in aberration diagrams which are arranged in order from the left side of the drawing sheet. The F numbers and the full angles of view shown in Table 5 as well as the aberrations illustrated in FIG. 9 are those for a case in which the distance from the lens surface most toward the magnification side to the magnification side conjugate point is 112.2.

TABLE 5
Example 3

| Si | Ri | Di | Ndj | νdj |
|---|---|---|---|---|
| 1 | 0.783 | 0.03 | 1.7725 | 49.6 |
| 2 | 0.949 | 0.07 | 1.4388 | 94.9 |
| 3 | −2.054 | 0.00 | | |
| 4 | 0.535 | 0.09 | 1.4970 | 81.5 |
| 5 | −1.343 | 0.02 | 1.7130 | 53.9 |
| 6 | 3.393 | DD [6] | | |
| 7 | 20.243 | 0.01 | 1.5673 | 42.8 |
| 8 | 0.286 | 0.03 | | |
| 9 | −1.143 | 0.01 | 1.6968 | 55.5 |
| 10 | 2.975 | 0.01 | | |
| 11 | −0.660 | 0.02 | 1.6204 | 60.3 |
| 12 | 1.496 | 0.01 | | |
| 13 | 1.153 | 0.02 | 1.8467 | 23.8 |
| 14 | −3.258 | DD [14] | | |
| 15 | 0.500 | 0.04 | 1.5378 | 74.7 |
| 16 | −2.162 | DD [16] | | |
| 17 | 0.358 | 0.05 | 1.6204 | 60.3 |
| 18 | 10.317 | 0.00 | | |
| 19 | 21.441 | 0.02 | 1.5750 | 41.5 |
| 20 | 0.376 | DD [20] | | |
| 21 | 0.850 | 0.02 | 1.8348 | 42.7 |
| 22 | 0.240 | 0.00 | | |
| 23 | 0.240 | 0.07 | 1.5952 | 67.7 |
| 24 | −4.301 | 0.01 | | |
| 25 | 0.425 | 0.07 | 1.6204 | 60.3 |
| 26 | −0.470 | 0.02 | 1.7725 | 49.6 |
| 27 | 0.671 | 0.13 | | |
| 28 | −0.301 | 0.01 | 1.5481 | 45.8 |
| 29 | 0.588 | 0.04 | | |
| 30 | 0.853 | 0.02 | 1.8000 | 29.8 |
| 31 | −3.491 | DD [31] | | |
| 32 | 0.972 | 0.03 | 1.8348 | 42.7 |
| 33 | −1.162 | 0.12 | | |
| 34 | ∞ | 0.28 | 1.5163 | 64.1 |
| 35 | ∞ | | | |

Zr = 1.50,
FNo. = 2.51~3.75,
2ω = 15.4°~10.2°

TABLE 6
Example 3

| | W-INF | T-INF | W-112.2 | T-112.2 | W-74.8 | T-74.8 |
|---|---|---|---|---|---|---|
| DD [6] | 0.151 | 0.151 | 0.156 | 0.156 | 0.159 | 0.159 |
| DD [14] | 0.355 | 0.088 | 0.350 | 0.083 | 0.340 | 0.073 |
| DD [16] | 0.002 | 0.058 | 0.002 | 0.058 | 0.002 | 0.058 |
| DD [20] | 0.094 | 0.124 | 0.094 | 0.124 | 0.094 | 0.124 |
| DD [31] | 0.019 | 0.201 | 0.019 | 0.201 | 0.019 | 0.201 |

Table 7 shows values corresponding to Conditional Formulae (1) through (4) for Examples 1 through 3. The values shown in Table 7 are related to the d line.

TABLE 7

| Formula | | Example 1 | Example 2 | Example 3 |
|---|---|---|---|---|
| (1) | f1b/ft | −0.16 | −0.12 | −0.21 |
| (2) | TLt/ft | 0.93 | 0.77 | 1.19 |
| (3) | D1G/DLt | 0.34 | 0.27 | 0.33 |
| (4) | Bfw/fw | 0.25 | 0.25 | 0.31 |

As can be understood from the above data, the zoom lenses of Examples 1 through 3 have small F numbers of approximately 2.5 at the wide angle end, and magnification side full angles of view of 16° or less at the wide angle end. The zoom lenses of Examples 1 through 3 are lens systems which are favorably suited for long focus, in which miniaturization is achieved, the reduction side is configured to be telecentric, favorably correct various aberrations, and realize high optical performance.

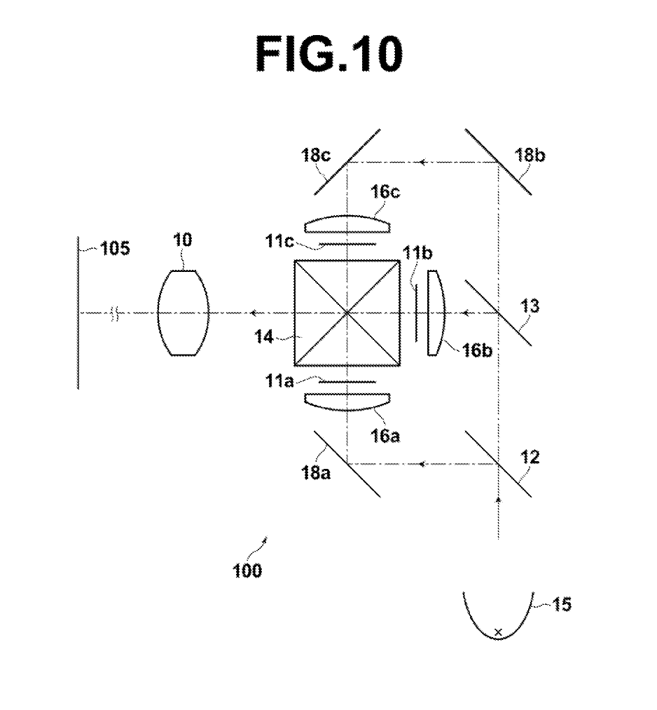

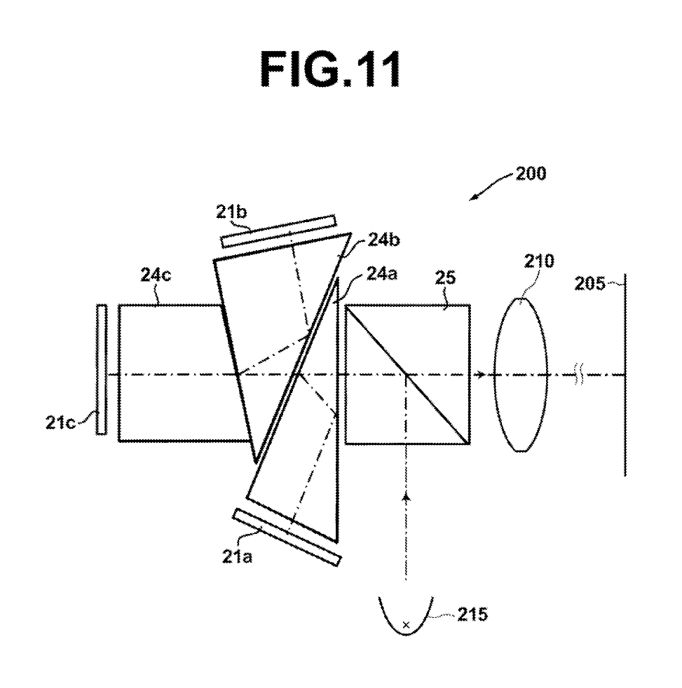

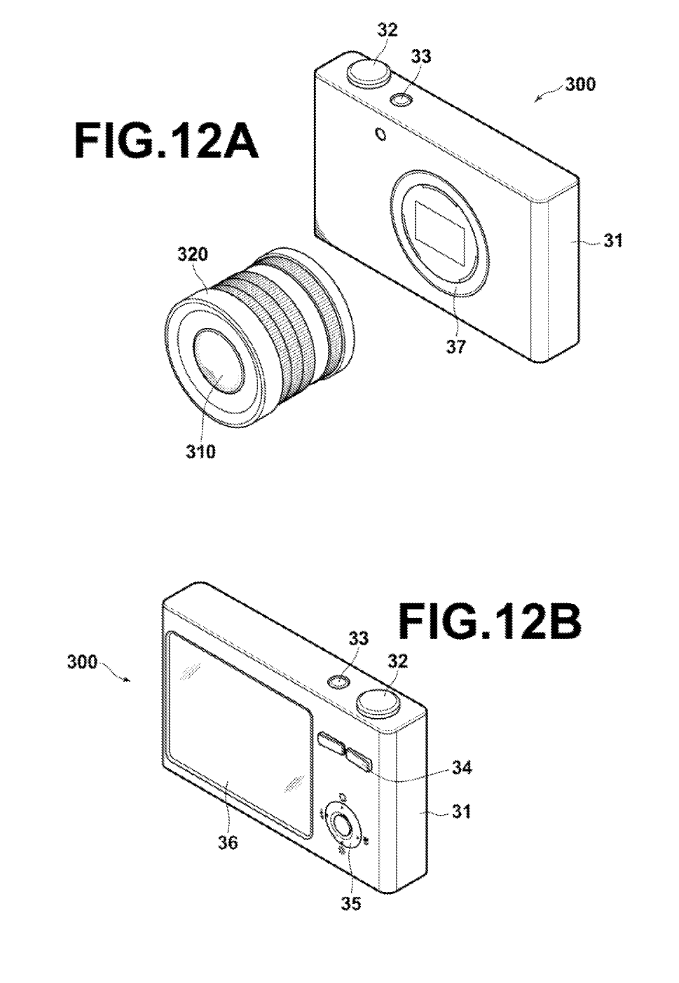

Next, embodiments of optical apparatuses of the present disclosure will be described with reference to FIG. 10, FIG. 11, FIG. 12A, and FIG. 12B. FIG. 10 is a diagram that illustrates the schematic configuration of a projection type display apparatus according to a first embodiment of the present disclosure. The projection type display device 100 illustrated in FIG. 10 is equipped with: a projection zoom lens 10, which is a zoom lens according to an embodiment of the present disclosure; a light source 15; transmissive display elements 11a through 11c that function as light valves each corresponding to a colored light beam; dichroic mirrors 12 and 13 for separating colors; a cross dichroic prism 14 for combining colors; condenser lenses 16a through 16c; and total reflection mirrors 18a through 18c for deflecting optical paths. Note that the projection zoom lens 10 is schematically illustrated in FIG. 10. In addition, although not illustrated in FIG. 10, an integrator is provided between the light source 15 and the dichroic mirror 12.

White light output by the light source 15 is separated into three colored light beams (G light, B light, and R light) by the dichroic mirrors 12 and 13. The colored light beams enters the transmissive display elements 11a through 11c corresponding thereto via the condenser lenses 16a through 16c and are optically modulated. After the colors are combined by the cross dichroic prism 14, the combined light beam enters the projection zoom lens 10. The projection zoom lens 10 projects an optical image formed by light which has been optically modulated by the transmissive display elements 11a through 11c onto a screen 105.

FIG. 11 is a schematic diagram that illustrates a projection type display device apparatus to a second embodiment of the present disclosure. The projection type display apparatus 200 illustrated in FIG. 11 is equipped with a projection zoom lens 210, which is a zoom lens according to an embodiment of the present disclosure, a light source 215, DMD (Digital Mirror Device: registered trademark) elements 21a through 21c as light valves each corresponding to a colored light beam; TIR (Total Internal Reflection) prisms 24a through 24c for separating and combining colors; and a polarization splitting prism 25 for separating illuminating light and projected light. Note that the projection zoom lens 210 is schematically illustrated in FIG. 11. In addition, although not illustrated in FIG. 11, an integrator is provided between the light source 215 and the polarization splitting prism 25.

White light output by the light source 215 passes through the polarization splitting prism 25, then is separated into three colored light beams (G light, B light, and R light) by the TIR prisms 24a through 24c. The three separated colored light beams enter the DMD elements 21 a through 21 c corresponding each of the light beams and are optically modulated thereby. Then, the optically modulated light beams propagate through the TIR prisms 24a through 24c in the reverse direction such that the colors are combined, pass through the polarization splitting prism 25, and enter the projection zoom lens 210. The projection zoom lens 210 projects an optical image formed by the light that enters thereinto onto a screen 205.

FIG. 12A and FIG. 12B illustrate the outer appearance of a camera 300, which is an imaging apparatus as an optical apparatus according to a third embodiment of the present disclosure. FIG. 12A is a perspective view of the camera 300 as viewed from the front, and FIG. 12B is a perspective view of the camera 300 as viewed from the rear. The camera 300 is a single lens digital camera which does not have a reflex finder, onto which an exchangeable lens 320 is interchangeably mounted. The exchangeable lens 320 is an imaging lens 310, which is a zoom lens according to an embodiment of the present disclosure, housed in a lens barrel.

The camera 300 is equipped with a camera body 31. A shutter release button 32 and a power button 33 are provided on the upper surface of the camera body 31. Operating sections 34 and 35 and a display section 36 are provided on the rear surface of the camera body 31. The display section 36 displays images which have been photographed and images within the angle of view prior to photography. A photography opening, in to which light from targets of photography enters, is provided at the central portion of the front surface of the camera body 31. A mount 37 is provided at a position corresponding to the photography opening. The exchangeable lens 320 is mounted onto the camera body 31 via the mount 37.

An imaging element (not shown), such as a CCD that receives images of subjects formed by the imaging lens 310 and outputs image signals corresponding to the images, a signal processing circuit (not shown) that processes the image signals output by the imaging element to generate images, and a recording medium (not shown) for recording the generated images, are provided within the camera body 31. In this camera 300, photography of a still image corresponding to a single frame or video imaging is enabled by pressing the shutter release button 32. Image data obtained by photography or video imaging are recorded in the recording medium.

The present disclosure has been described with reference to the embodiments and Examples thereof. However, the zoom lens of the present disclosure is not limited to the embodiments and Examples described above, and various modifications are possible. For example, the values of the radii of curvature, the distances among surfaces, the refractive indices, and the Abbe's numbers of each lens component may be changed as appropriate.

In addition, the optical apparatus of the present disclosure is not limited to those having the configurations described above. For example, the light valves and the optical members which are employed to separate or combine light beams in projection display devices are not limited to the configurations described above, and various changes are possible. In addition, a single lens digital camera which does not have a reflex finder was described as the embodiment of the imaging apparatus to which the present disclosure was applied. However, the present disclosure is not limited to this use, and the zoom lens of the present disclosure may be applied to a single lens reflex camera, a film camera, a video camera, a television camera, and the like as well.

What is claimed is:

1. A zoom lens, comprising:
a first lens group, which is fixed when changing magnification, provided most toward the magnification side; and
a second lens group having a positive refractive power, which moves when changing magnification, provided adjacent to the first lens group at the reduction side of the first lens group;
the first lens group consisting of, in order from the magnification side to the reduction side, a front group having a positive refractive power and a rear group having a negative refractive power, focusing operations being performed by changing the distance between the front group and the rear group; and
Conditional Formula (1) below being satisfied:
−0.35≦flb/ft≦0 (1)
wherein flb is the focal length of the rear group, and ft is the focal length of the entire lens system at the telephoto end.

2. A zoom lens as defined in claim 1, in which Conditional Formula (2) below is satisfied:
0.5≦TLt/ft≦1.5 (2)
wherein TLt is the sum of the distance along the optical axis from the lens surface most toward the magnification side to the lens surface most toward the reduction side and an air converted distance from the lens surface most toward the reduction side to the reduction side focal point position at the telephoto end.

3. A zoom lens as defined in claim 1, in which Conditional Formula (3) below is satisfied:
0.1≦D1G/DLt≦0.45 (3)
wherein D1G is the distance along the optical axis from the lens surface most toward the magnification side to the lens surface most toward the reduction side within the first lens group, and DLt is the distance along the optical axis from the lens surface most toward the magnification side to the lens surface most toward the reduction side at the telephoto end.

4. A zoom lens as defined in claim 1, wherein:
a lens group having a positive refractive power, which is fixed when changing magnification, is provided most toward the reduction side; and
the reduction side is configured to be telecentric.

5. A zoom lens as defined in claim 1, in which Conditional Formula (4) below is satisfied:
0.05≦Bfw/fw≦0.4 (4)
wherein Bfw is an air converted distance from the lens surface most toward the reduction side to the reduction side focal point position at the wide angle end, and fw is the focal length of the entire lens system at the wide angle end.

6. A zoom lens as defined in claim 1, wherein:
the entire lens system consists of five or six lens groups; and
the distances among adjacent lens groups change when changing magnification.

7. A zoom lens as defined in claim 1, consisting of, in order from the magnification side to the reduction side,
the first lens group;
the second lens group;
a third lens group having a positive refractive power;
a fourth lens group having a negative refractive power;
a fifth lens group having a negative refractive power; and
a sixth lens group having a positive refractive power;
the second lens group, the third lens group, the fourth lens group, and the fifth lens group being moved such that the distances among adjacent lens groups change when changing magnification; and
the sixth lens group being fixed when changing magnification.

8. A zoom lens as defined in claim 1, consisting of, in order from the magnification side to the reduction side,
the first lens group;
the second lens group;
a third lens group having a positive refractive power;
a fourth lens group having a negative refractive power; and
a fifth lens group having a positive refractive power;
the second lens group, the third lens group, and the fourth lens group, being moved such that the distances among adjacent lens groups change when changing magnification; and
the fifth lens group being fixed when changing magnification.

9. A zoom lens as defined in claim 1, in which Conditional Formula (1-1) below is satisfied:
−0.29≦flb/ft≦−0.05 (1-1).

10. A zoom lens as defined in claim 2, in which Conditional Formula (2-1) below is satisfied:
0.6≦TLt/ft≦1.4 (2-1).

11. A zoom lens as defined in claim 3, in which Conditional Formula (3-1) below is satisfied:
0.2≦D1G/DLt≦0.4 (3-1).

12. A zoom lens as defined in claim 5, in which Conditional Formula (4-1) below is satisfied:
0.1≦Bfw/fw≦0.35 (4-1).

13. An optical apparatus equipped with a zoom lens as defined in claim 1.
